(19) United States
(12) Patent Application Publication
(10) Pub. No.: US 2014/0372119 A1
(43) Pub. Date: Dec. 18, 2014

(54) Compounded Text Segmentation

(71) Applicants: Carolina Parada, Baltimore, MD (US); Boulos Harb, New Haven, CT (US); Johan Schalkwyk, Scarsdale, NY (US)

(72) Inventors: Carolina Parada, Baltimore, MD (US); Boulos Harb, New Haven, CT (US); Johan Schalkwyk, Scarsdale, NY (US)

(73) Assignee: Google, Inc.

(21) Appl. No.: 12/568,014

(22) Filed: Sep. 28, 2009

Related U.S. Application Data
(60) Provisional application No. 61/100,589, filed on Sep. 26, 2008.

(51) Int. Cl. G10L 17/00; G06F 17/30; G06F 15/18

(52) U.S. Cl. 704/246; 707/803; 707/706; 707/E17.044; 707/E17.108; 706/12; 704/E15.001

(57) ABSTRACT

In general, the subject matter described in this specification can be embodied in methods, systems, and program products for performing compounded text segmentation. Compounded text that is extracted from one or more search queries submitted to a search engine is received. The compounded text includes a plurality of individual words that are joined together without intervening spaces. An electronic dictionary including words is accessed. A data structure representing possible segmentations of the compounded text is generated based on whether words in the possible segmentations occur in the electronic dictionary. A data store comprising data associated with a same field of usage as the compounded text is accessed to determine a frequency of occurrence for possible segmentations of the data structure. A segmentation of the compounded text that is most probable based on the data is determined. A language model is trained using the determined segmentation of the compounded text.

### CLAIM OF PRIORITY

This application claims the benefit under 35 U.S.C. §119 of U.S. Provisional Application No. 61/100,589, titled “Compounded Text Segmentation,” filed Sep. 26, 2008, which is incorporated by reference herein in its entirety.

### TECHNICAL FIELD

This instant specification relates to segmenting and desegmenting text for speech recognition purposes.

### BACKGROUND

Improvements in processing capability of mobile devices and increased speed of wireless service providers have brought about an increased use in smartphones. Such smartphones can be loaded with various software applications, including notetaking applications, calendars, email, and the web browsers. The ability to access the Internet while remote from a desktop computer is convenient to smartphone users. For example, a user can employ search capabilities on a smartphone while the user is on the go, to find information that is immediately important to them. At certain times, however, a user should not be typing data into a smartphone, such as when the user is driving an automobile.

### SUMMARY

Search queries on mobile devices contain a relatively large fraction of navigational queries (e.g., queries where the user types a universal resource locator (URL) into a search box of a web page for a search engine in order to navigate to the desired web site such as facebook.com, myspace.com, and youtube.com). Users also type URLs into search boxes to obtain information about web sites or to get search results that are directed to specific pages (e.g., a query of “Customer Service Phone Number barnesandnoble.com”). Users may provide such information by typing it, or they may speak it into a device that has, or is connected to a system that has, voice recognition capabilities.

The convenience of entering such navigational queries may make building a Spoken Query Language Model for use by an Automatic Speech Recognition (ASR) system challenging. Such a language model (LM) may use statistics of search queries to compute probabilities to be assigned to queries that are spoken to the ASR system. Incorporating URLs in a Spoken Query LM may be a challenge since a URL will be input to the ASR system in its spoken form, and not its standard textual form. Further, incorporating URLs in a Spoken Query LM can also unduly increase the size of the LM.

This document describes how to train on and recognize URLs in their spoken form. The spoken form of a URL is the way in which a person would say the URL. For example, one reads the URL “cancercentersofamerica.com” as “cancer centers of america dot com.” More formally, the spoken form of a URL is an underlying true segmentation of the URL into its constituent words. In some of the implementations subsequently described, systems compute segmentations of URLs in search query data that resemble the spoken forms of the URLs as closely as possible.

The segmentation of the URLS can be based off of large language models built from a web query stream. A query stream can provide a more robust vocabulary for decompounding URLs than can other forms of dictionaries. For example, the words typed by users into a search engine system are more likely to be included in a URL than are words from a dictionary that is not drawn from a web query stream.

In certain of the examples described here, the computation of URL segmentations is performed by training a URL decompounding transducer to identify, for a set of URLs, the most probable decomposition of the URLs into their constituent words. The decomposition is performed by generating a finite state transducer for each URL that represents all possible segmentations of the URL based upon the vocabulary of a language model. The segmentation of the URL that is associated with the highest probability score in the language model is stored as the decomposition of the specific URL. The segmentation and language model scoring is performed for all the URLs in a training set for the URL transducer.

This document also describes the use of a trained decompounder to normalize segmented spoken phrases into a URL. For example, a user of a search engine application on a mobile telephone can speak “The Dinosaur Zoo Dot Com” into the telephone and view search results for “thedinosaurzoo.com.” The text query displayed by the search engine application to the user is “thedinosaurzoo.com,” not “The Dinosaur Zoo Dot Com.” The normalization is performed by inverting the trained decompounder—creating a compounder—and inputting a sequence of words into the compounder. If an input sequence of words is associated with a URL that was used in training the decompounder, the compounder outputs the URL.

In general, one aspect of the subject matter described in this specification can be embodied in a computer-implemented method that includes receiving a textual form of a uniform resource locator (URL) comprising a plurality of individual words that are joined together without intervening spaces. Based on words that are present in an electronic dictionary, a lattice of possible words that are represented in the textual form of the URL are generated. The lattice includes paths that each include one or more possible words and a sequence for the one or more possible words. Search query data is accessed to determine, for each of the paths, probabilities of occurrence for n-grams that correspond to the path. A path associated with a highest probability of occurrence as a representation of a spoken form of the URL is selected. Other embodiments of this aspect can include corresponding computer program products and systems.

Another aspect of the subject matter described in this specification can be embodied in a computer-implemented method that includes receiving compounded text extracted from one or more search queries submitted to a search engine. The compounded text includes a plurality of individual words that are joined together without intervening spaces. An electronic dictionary including a plurality of words is accessed. A data structure representing possible segmentations of the compounded text based on whether words in the possible segmentations occur in the electronic dictionary is generated. A data store comprising data associated with a same field of usage as the compounded text is accessed to determine a frequency of occurrence for one or more of the possible segmentations of the data structure. A segmentation of the compounded text that is most probable based on the data in the data store is determined. A language model using the determined segmentation of the compounded text is trained. Other embodiments of this aspect can include corresponding computer program products and systems.

Another aspect of the subject matter described in this specification can be embodied in a system that includes an electronic dictionary of words. A first language model includes information that identifies a frequency of usage of words in the electronic dictionary. An automaton identifies possible segmentations of URLs into individual words from the electronic dictionary. A path calculator identifies, based on the information that identifies a frequency of usage of the words, a most probable segmentation of the URLs from the possible segmentations identified by the automaton. A trained automaton stores the most probable segmentations of the URLs from the possible segmentations of the URLs. Other embodiments of this aspect can include corresponding methods and computer program products.

Another aspect of the subject matter described in this specification can be embodied in a system that includes an interface for a server system to receive a voice query from a mobile device. A decompounder is installed at the server system and receives uniform resource locators (URLs) and generates a segmentation of each URL into constituent words. A language model is installed at the server system and is adapted to receive the voice query from the mobile device and identify a sequence of text words that correspond to the spoken words of the voice query. The language model is trained to identify the sequence of text words based on the constituent words generated by the decompounder for the URLs. A compounder is installed at the server system to translate the sequence of text words into a textual URL. Other embodiments of this aspect can include corresponding methods and computer program products.

These and other embodiments can optionally include one or more of the following features. The textual form of the URL can be extracted from second search query data. The URL to be extracted can be identified, based on a presence of an Internet domain name or an Internet domain suffix. An extracted textual form of the URL can be annotated with an identifier that specifies that the URL is a URL. Selecting the path associated with the highest probability can include an implementation of an equation N(u)=bestpath(I(u)∘T*(VBase)∘LBase), where * is the Kleene Closure, ∘ is the composition operator, N (u) is the selected path, (I(u)∘T*(V_{Base})) represents the lattice, I represents a first transducer that maps each character in the URL to itself, T represents a second transducer that maps a sequence of characters into words, V_{Base} represents the electronic dictionary and L_{Base} represents the search query data. The one or more words of the selected path can be output to a voice language model as the representation of the spoken form of the URL. The voice language model can be trained using the output one or more words and using frequency data for the output one or more words. A trained decompounder that outputs a textual representation of the spoken from of the URL in response to receiving as input the URL can be generated based on the selected path for the URL. Audio data that includes a spoken query can be received from a computing device. A textual form of words in the spoken query can be identified using a language model. The textual form of the words can be input into a compounder. The compounder can be formed by inverting the trained decompounder. A concatenation of at least some of the words can be received as output from the compounder so that the at least some words are joined together without intervening spaces. The concatenation of words can be transmit as a query to a search engine system. Audio data that includes a spoken URL from a user of a mobile computing device can be received.

The compounded text can include a URL. The compounded text can include a language that does not segment every word in the language's written form. The data associated with the same field of usage can include search queries previously identified as full or partial URLs. The determined one or more segmentations that are most probable as a spoken form of the URL can be output.

A second language model can be trained using the most probable segmentations of the URLs in the trained automaton. A compounder can receive as a textual input the most probable segmentations of the URLs and output the URLs. The compounder can be formed by inverting the trained automaton. A mobile device can transmit a voice query to a server system that includes the compounder. The transmitted voice query can be provided to the second language model that is trained using the segmentations of the URLs. A search engine system on the server system can receive from the compounder a URL that includes a plurality of textual words form the voice query joined together without intervening spaces. The search engine system can transmit to the mobile device search results that are responsive to the URL. The compounder can be generated by inverting the decompounder. A search engine system can be installed at the server system to receive the textual URL from the compounder and to generate search results that are responsive to the received textual URL. The search engine system can transmit the textual URL and the search results that are responsive to the textual URL for display on the mobile device. The decompounder can be created by generating, for each of the URLs and based on words present in an electronic dictionary, a lattice of possible words represented in a textual form of the URL. The lattice can include paths that each include one or more possible words and a sequence for the one or more possible words. Search query data can be accessed to determine for each of the paths, probabilities of occurrence for n-grams that correspond to the path. For each of the URLs, a path can be selected in the URL's lattice that is associated with a highest probability of occurrence as a representation of a spoken form of the URL. For each URL, constituent words associated with the selected path URL can be stored in the decompounder.

The systems and techniques described here may provide one or more of the following advantages. First, a very large language model that includes information such as search queries can be used to determine the most probable segmentation for a compounded form of a URL. The use of such a large language model may enable the system to more accurately predict a correct sequence of decompounded words.

For example, some of the described systems and methods may consider all possible segmentations of a given URL (or more generally text) using words available in the vocabulary of a large language model (e.g., the vocabulary of the LM may include about one million words). The systems or methods can use the language model to assign a probability to each one of these segmentations and output the segmentation with the highest probability. In some implementations, an LM is used that includes a trigram model with more than 12 billion n-grams.

Second, an automaton can be used to compactly represent in memory substantially all possible segmentations for given compounded text. Third, the described systems or methods can be used in certain implementations to build a language model for a voice search system that enables a user to navigate the web via voice commands that include spoken URLs. The language model can be trained using frequency data for text URLs to better recognize spoken phrases corresponding to URLs. A compounder can also be used to translate a series of spoken words into a URL. Fourth, the size of a language model's vocabulary may be reduced. Fifth, the perplexity of the language model may be reduced. Sixth, the automatic generation of a pronunciation for a URL using pronunciations for its constituent words may be enabled.

The details of one or more embodiments are set forth in the accompanying drawings and the description below. Other features and advantages will be apparent from the description and drawings, and from the claims.

### DESCRIPTION OF DRAWINGS

FIG. 1 is an example system for training a URL decompounding transducer.

FIG. 2 is an example lattice I(u)∘T(VBase) of all possible segmentations for u=myspacelayouts using words in VBase.

FIG. 3 is an example system for preparing data for a speech recognition model.

FIG. 4 is an example automaton T(S) for a set of words S={my, space, myspace, lay, outs, layouts}, where ‘eps’ denotes epsilon.

FIG. 5 is an example system for compounding spoken words.

FIG. 6 is a flow chart of an example process for identifying constituent words in a URL.

FIG. 7 is a flow chart of an example process for generating a URL from a spoken representation of the URL.

FIG. 8 is a figure of a computing devices that may be used in implementations of the systems and methods described herein.

Like reference symbols in the various drawings indicate like elements.

### DETAILED DESCRIPTION

This document describes systems and techniques for segmenting compounded text and desegmenting decompounded text using a large statistical language model (LM). An LM can be effective for segmenting compounded text, for example, if both the model and the text are drawn from compatible domains. In some implementations, the subsequently described systems and techniques accurately segment uniform resource locators (URLs) into their constituent words using an LM trained on search query data.

To navigate the Internet, many search engine users may type URLs or partial URLs into a search box of a search engine web page instead of entering the URLs into an address bar of a browser. Users may also wish to enter these URLs or partial URLs, also referred to as forms of navigational queries, via voice commands. Internet navigation by voice is an attractive method to navigate the web, especially for users of mobile devices that may have restrictive methods for typing text. Navigation by voice is also attractive for users of smartphones who are using their hands for other tasks.

However, URLs are often a concatenation of words (e.g., cnn.com, drudgereport.com, nytimes.com, cancercentersofamerica.org). Because of this compounding of words, it may be difficult even for humans to associate a URL with a spoken form of the URL (e.g., gothisland.com may be segmented as either “go this land” or “goth island”).

In some implementations, a system is described that generates possible segmentations for a compounded text using a dictionary of words to determine what segmentations are available for that text. In some implementations, the electronic dictionary includes a language model that has a million or more words that include all the alphabet, proper nouns, names, all English words, slang, etc.

In some implementations, the segmentations are stored in a factor automaton, which is described in greater detail below.

Once the segmentations for a compounded text are created, the system can access a large set of data in the same information domain as the compounded text. For example, if the compounded text is a URL, then the system can access a language model (LM) that includes navigational search queries (e.g., segmented URL's entered into a search engine by a user). The set of data can include information about the frequency that particular terms within the data occur. In some implementations, if the data includes search queries, the data may be annotated with information that specifies how many times terms, or n-grams (e.g., n sequences of phonemes, syllables, letters, words, base pairs, etc.), occur within the data, for example, during a specified period of time.

The system may assign each possible segmentation (and strings of segmentations) a probability that is based on the frequency information associated with n-grams that correspond to the possible segmentations (and strings of segmentations).

The system can then select the segmentation or sequence of segmentations that have the greatest probability as the best spoken representation for the compounded text. The selected segmentation for each URL can be stored in another automaton that represents a trained decompounder. The trained decompounder can receive URLs and output their constituent words without accessing a vocabulary to segment the URL or a language model to score the possible segmentations. The spoken representation for the compounded text can be incorporated into a voice language model, which is used to recognize audio data (e.g., audio streams that include voice queries).

Training the language model with URLs can appropriately assign probabilities to the language model to identify received search engine queries. For example, a language model that has been trained without URLs may recognize the spoken query “Facebook” as “Case Book” (e.g., because queries for “Case Book” are more common than regular queries for “Face Book.” On the other hand, if sequences of words decompounded from URLs are incorporated into the model the probability of the phrase “Face Book” may increase. This is because the website www.facebook.com is likely entered as a navigational query more often than www.casebook.com.

A decompounder and language model that is trained with URLs can be used to more accurately recognize voice queries that include URLs, than can a model that is not trained in this manner. For example, a user of a mobile telephone can speak the query “cancer centers of america dot com.” A speech recognition engine can access the voice language model to determine a probable sequence of spoken words in the query. The trained decompounder can be inverted (to produce a compounder) and the selected sequence of words can be fed into the decompounder. If a URL representation for the spoken query exists, the speech recognition engine (or another component) can return the textual form of the URL, namely, www.cancercentersofamerica.com, to the user. In some implementations, the mobile device can then use the textual form of the URL to automatically navigate to the resource identified by the URL.

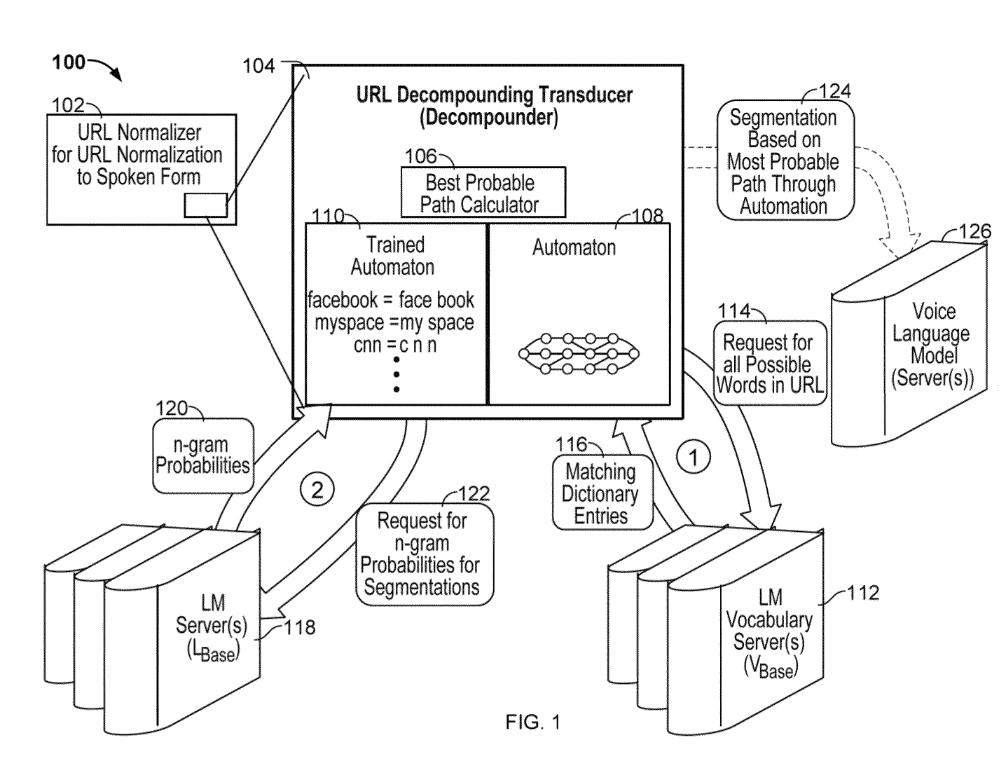

FIG. 1 is an example system for training a URL decompounding transducer. The system includes a URL normalizer 102 that can receive a set of URLs and convert the URLs into their constituent words. To perform the conversion, the URL normalizer 102 includes a URL decompounding transducer, or decompounder 104. The decompounder 104 accesses a language model vocabulary 112 to construct an automaton 108 that represents every possible segmentation of a URL into the constituent words that may be included in the URL and identified by the vocabulary 112. The segmentation with the highest probability based on probabilities in a language model 118 is placed in a trained automaton 110. The trained automaton receives URLs as input, and outputs the previously identified most probable segmentation of the URL based on the language model 118.

The URL Normalizer 102 receives at least one URL and can normalize the URL to its spoken form. For example, the URLs “facebook.com,” “myspace.com,” and “cnn.com” are fed into the URL normalizer 102 and the normalizer respectively outputs “face book,” “my space,” and “c n n.” The component that identifies the set of constituent words for an input URL is the URL decompounding transducer 104 (the “decompounder”).

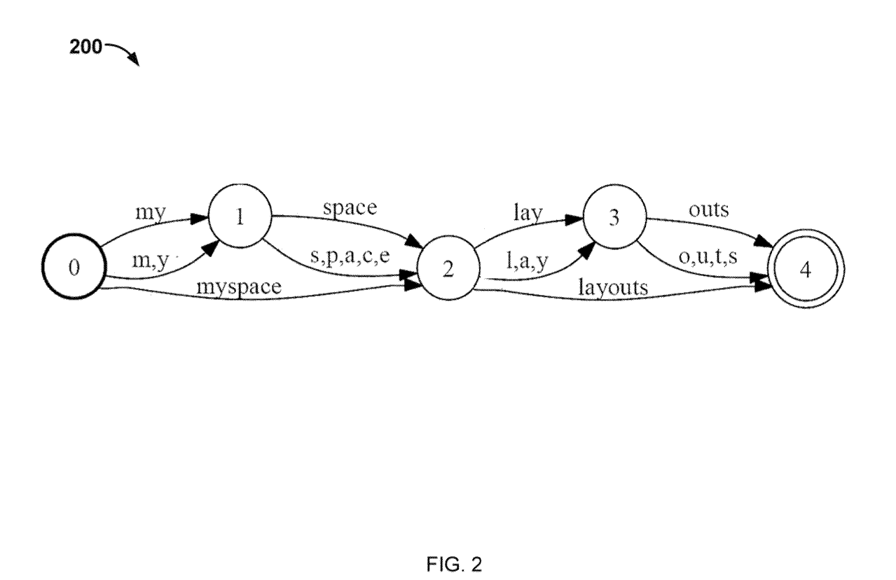

If the decompounder 104 includes a trained automaton 110, the URL normalizer 102 can identify constituent words in a URL without accessing a vocabulary 112 or language model 118. In this illustration, however, the decompounder 104 does not identify constituent words for “myspacelayouts.com” and must train the automaton 110 to output the constituent words for “myspacelayouts.com.” The first step is to build a separate automaton 108 that represents a lattice structure of all the possible segmentations of the string “myspacelayouts.” See FIG. 2 for a completed lattice for the string “myspacelayouts.”

To generate the lattice automaton 108, the decompounder 104 needs a list of possible constituent words for the phrase “myspacelayouts.” The decompounder 104 issues a request 114 for all the possible words in a URL. The request is transmitted with the URL to a vocabulary server 112, which includes a vocabulary that is drawn from a query stream. For example, the vocabulary is a list of the one million most common words entered into a search engine system. In this illustration, the vocabulary is the vocabulary for the language model 118.

The vocabulary server 112 includes an automaton that receives as input the URL from the request and outputs all words in the vocabulary that can be identified within the URL. The vocabulary server 112 transmits these words back as matching dictionary entries 116.

The decompounder 104 generates the lattice automaton 108 using the matching dictionary entries 116. As an example, FIG. 2 is an example lattice I(u)∘T(V_{BASE}) of all possible segmentations for u=myspacelayouts using words in V_{BASE}. Each of the many paths through the lattice automaton 108 is a potential decomposition of the URL, and in Table 1 a sample of these possible segmentations indicated by the paths is listed.

TABLE 1
Sample Segmentations from FIG. 2, the one in bold represents the
highest probability path as determined by the composition with L_{BASE}.
POSSIBLE SEGMENTATIONS

myspace layouts
my space layouts
my space lay outs
my space l a y outs

The automaton is traversed by inputting “myspacelayouts” at node 0. The output to node 0 includes the edges “my” “m, y” and “myspace.” If the “my” output edge is traversed, the word “my” is consumed from the input string and the next state of the automaton is at node 1. The entire lattice is traversed in this manner until the input string is consumed and the final node 4 is reached. Upon reaching the final node, the constituent words of the path traversed are output. The lattice automaton 108 and 200 are described as representing a finite state transducer, however, other forms of automatons may be used (e.g., a finite state table). In some implementations, a lattice automaton 108 is generated for every URL. In other implementations, a single lattice automaton 108 is generated for a set of URLs (e.g., all URLs input into the URL normalizer 102).

To score each edge in the lattice automaton 108, a request for probabilities of the segmentations 122 is sent to a language model server 118. The language model server can be generated from a search engine query stream and be an n-gram model (e.g., a tri-gram model). In some implementations, the query stream used to train the model does not include query terms that are identified as URLs. In such implementations, the vocabulary 112 does not include terms that are identified from segmented URLs. In some implementations, the query stream is derived from textual queries (e.g., those entered into a search engine web page by a user sitting at a computer and using a keyboard), not voice queries.

The language model is applied to the lattice automaton 108, or portions thereof, to identify probabilities for each transition from one node to another. For example, the transitions (or edges) from node 0 to node 1 may be assigned probabilities of 0.8 for the edge “my” and 0.2 for the edge “m, y.” The transition from node 0 to node 2 for the edge “myspace” can be assigned a probability of 0.5. The language model returns the probabilities to the decompounder 104. In some implementations, the probabilities are stored in the automaton 108 or another component associated with the decompounder 104.

The best probable path calculator 106 identifies the path through the lattice automaton 108 that is associated with the highest probability. As an illustration, and with reference to the lattice in FIG. 2, the calculated probability for “m y s p a c e l a y o u t s” is 1.6, “my space lay outs” is 5.4, “m y space l a y outs” is 0.3, and “myspace layouts” is 6.2. The segmentation “myspace layouts” is assigned the highest probability.

In some implementations, the automaton is generated and scored every time a URL is received by the normalizer 102. The process of generating a lattice automaton 108 and scoring it requires substantial processing capability and is time-intensive. For the instances where a set of URLs includes duplicative URL entries, processing can be minimized by training an automaton 110 with the result of the best probable path calculation.

Therefore, in some implementations, a trained automaton 110 is generated based on the best probable path calculation through the lattice automaton 108. The trained automaton can identify highest probability segmentations for a set of URLs. For example, the trained automaton 110 can be trained for the strings “facebook,” “myspace” and “cnn.” If these strings are input into the trained automaton 110 at a later point in time, the automaton outputs “face book,” “my space,” and “c n n” separately.

If a string is input into the trained automation 110 and a set of constituent words is not identified (e.g., if the string “billscrabshack.com” is input), the trained automation can indicate that no matching set of constituent words was found (e.g., by outputting a “0”). In some implementations, the decompounder 102 acknowledges that the string does not contain constituent words. For example, the input URL may have been included in a training set of URLs, but the lattice URL did not include any constituent words from the vocabulary 112. In other implementations, if no matching set of constituent words is identified, a lattice automaton 108 is generated for the URL and a best probable path 106 is calculated for the URL. The identified probable constituent words can be added to the trained automaton.

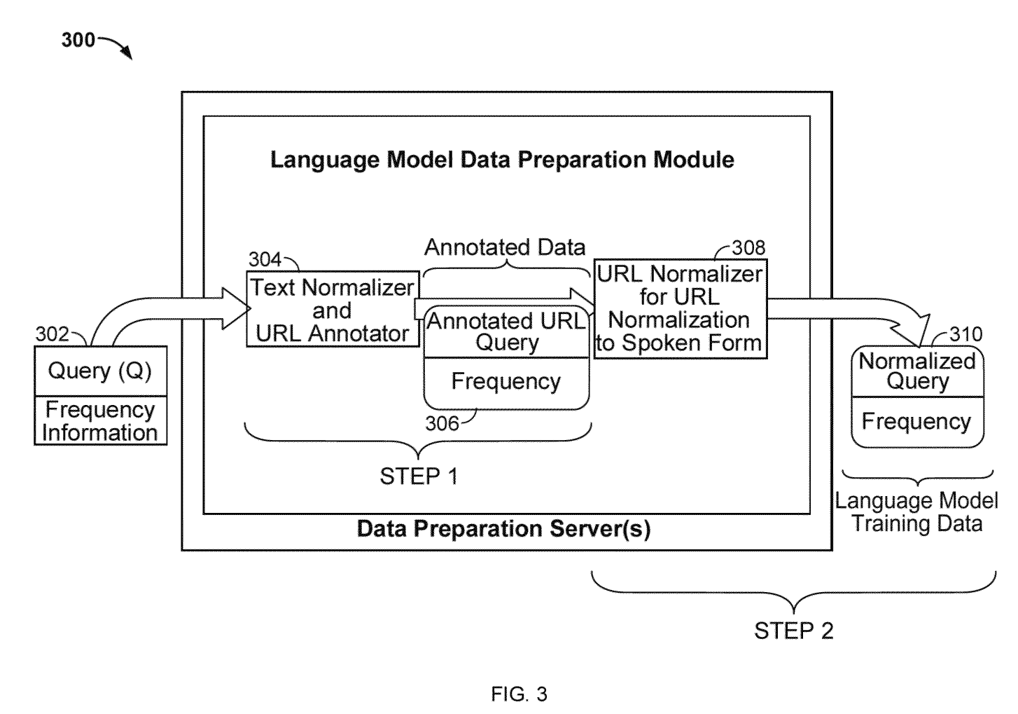

In some implementations, the identified most probable constituent words for a set of URLs is output 124 along with frequency data as the segmentation based on the most probable path through the automaton. The output segmentation and frequency data can be used to train a voice language model 126. This process is described in more detail with reference to FIG. 3.

In other implementations, the decompounder 104 is used to identify constituent words in a URL for a URL-to-spoken-text generator. For example, the URL “facebook.com” can be decompounded into its constituent words “face book dot com” and a voice generator can output using speakers the phrase “face book dot com.” If a URL is received that is not in the trained automaton 110, a lattice automaton 108 can be created for the URL and the best probable path calculator 106 identifies the most probable constituent words. The new URL may be added to the trained automaton 110. This application of the decompounder can lead to enhanced audible representations of spoken text in audio books, for use rendering text with mobile devices, and for various applications benefiting the visually impaired.

FIG. 3 is an example system for preparing data for speech recognition. The description for FIG. 3 builds on the description for FIG. 1, and describes implementations for building a Spoken Query Language Model for use by an automatic speech recognition (ASR) system. For example, such a language model may use statistics of search queries to compute the probabilities assigned to queries spoken to the ASR system. Specifically, this following description includes example implementations of how to train on and recognize universal resource locators (URL) in their spoken form. As previously mentioned, an interesting phenomenon of search queries is that they contain a relatively large fraction of navigational queries; e.g., facebook.com, myspace.com, cnn.com. Incorporating them in the language model (LM) for an ASR system presents a challenge since a URL is input to the ASR system in its spoken form, and not its standard textual form.

The spoken form of a URL is the way in which a person would say the URL. More formally, the spoken form of a URL u is an underlying true segmentation of the URL into its constituent words u=u^{m}₁=u₁, u₂, . . . , uₘ. One step is to find segmentations of URLs in query training data that resemble the spoken forms of the URLs as closely as possible. That is, given a URL u, the system should find a segmentation û=û^{k}₁ of u such that û is close to u^{m}₁. This is referred to as decompounding u, and the closeness is measured using the string edit distance—or word error rate (WER).

Example methods are described that segment the written form of the URL into its spoken form by creating a finite-state transducer (FST) that can decompound URLs in our training data. The benefits of the decompounding FST may be two-fold.

First, it may reduce the size of the language model's vocabulary. Let the set of URLs appearing in the training set be U and let W(U) contain the constituent words produced by the decompounding FST for all u with the set of U. Then instead of using u within the set of U as a training sample, the sequence û^{k}₁ can be used, thus modeling the n-grams appearing in u and, assuming |W(U)|<<|U|, significantly reducing the size of the vocabulary.

For example, training a model on the URLs (1) myspace.com, (2) myspacelayouts.com, (3) myspacefavoritepeople.com, (4) favoritepeople.com, (5) layouts.com, (6) space.com, and (7) my.com requires 7 URL entries in the language model in addition to at least 6 entries for the words “my,” “space,” “lay,” “outs,” “favorite,” and “people.” In contrast, if the URLs are decompounded into their constituent words, only the 6 entries for the constituent words are necessary.

Second, it may enable the automatic generation of a pronunciation for a URL u using pronunciations for the words that constitute u. That is, by decompounding u into û^{k}₁, in order to generate a pronunciation for u, it suffices to generate pronunciations for {û₁, . . . , ûₖ}. For example, pronunciations for “cancer” “centers” “of” “America” are sufficient to generate a pronunciation for “cancercentersofamerica.” A new entry is not required.

Below, example implementations are described detailing how to build the decompounding FST, and the relevant aspects of the system's architecture for building language models. Also, descriptions of an experimental setup are described. Finally, experimental results quantifying the benefits of using the decompounding FST in training a Query language model are described.

Segmentation Using Large Scale LMS

In this section, the segmentation algorithm for decompounding URLs into their spoken constituents is described. A distributed language modeling architecture is described wherein the data preparation phase as it will be relevant for constructing and utilizing the URL decompounding FST is also described. Additional details for the decompounding FST are explained in Section 2.2. For background on finite-state transducers, the reader is referred to A. Salomaa and M. Soittola, Automata: Theoretic aspects of formal power series, Springer-Verlag, New York, 1978 and W. Kuich and A. Salomaa, Semirings, automata, languages, vol. 5 of EATCS Monographs on Theoretical Computer Science, Springer-Verlag, Berlin, 1986. See also M. Mohri, F. Pereira, and M. Riley, “Weighted finite-state transducers in speech recognition,” Computer Speech and Language, vol. 16, no. 1, pp. 69-88, January 2002. See also M. Mohri, F. Pereira, and M. Riley, “Weighted finite-state transducers in speech recognition,” Computer Speech and Language, vol. 16, no. 1, pp. 69-88, January 2002 for a survey on their use in speech recognition. In some implementations the OpenFst library can be used for constructing FSTs. Note that all query data is anonymized before performing the processing steps described below. See C. Allauzen, M. Riley, J. Schalkwyk, W. Skut, and M. Mohri, “OpenFst: A general and efficient weighted finite-state transducer library,” in Proc. CIAA. 2007, vol. 4783 of LNCS, pp. 11-23, Springer, http://www.openfst.org.

Language Modeling Architecture

Building a language model from query data in a system is performed in a distributed manner using, for example, MapReduce. See J. Dean and S. Ghemawat, “MapReduce: Simplified data processing on large clusters,” in Sixth OSDI Symposium, San Francisco, Calif., 2004. The data is first normalized and annotated as depicted in FIG. 3 (this phase may be referred to as the data preparation phase). It may then be passed on to the language model training framework described in (the LM training phase). See T. Brants, A. C. Popat, P. Xu, F. J. Och, and J. Dean, “Large language models in machine translation,” in Proc. EMNLP-CoNLL, Prague, June 2007, pp. 858-867.

In some implementations, the data preparation phase consists of two steps. The first step (Step 1 in FIG. 3) is a distributed computation that normalizes and annotates input data 302. The input data can include a collection of queries from a search engine and frequency information for the queries. For example, the queries may be textual queries input by users of a search engine website. As an illustration, the input data can include “Britney Spears, 56” “Dinosaurs 17” and “myspace.com 3,” where the number is the frequency of the queries over a period of time.

Standard text normalization is performed in this step; for example, converting all characters to lower case, and removing certain punctuation characters. Given a query, annotation involves identifying substrings of the query that are URLs. This may be accomplished using regular expressions. For example, an annotation may simply be a label that marks a query, or a substring of it, as a URL. The text normalizer and URL annotator 304 can perform the described normalization of text and annotation of URLs. In some implementations, the queries (or portions thereof) are stored in a database. Metadata can identify those substrings that are URLs.

Since the input is now normalized, it can be used for training, and as described in Section 3 the language model L_{BASE} may be built from this data. In some implementations, L_{BASE} is only built from the non-annotated query data (i.e., L_{BASE} does not include URLs). L_{BASE} can be used to assign probabilities to URL segments and the segments identified as most probable can be used to train a new language model. In some implementations, the new language model replaced L_{BASE}.

Since the URLs are also annotated, it is possible to perform context-aware normalization on the substrings labeled as URLs. Indeed, this is one place where the URL decompounder 308 may be utilized: to segment queries (or substrings thereof) that are marked as URLs before passing them to the LM training phase so that they resemble their spoken form. This normalization may take place in the second step (Step 2 in FIG. 3) of the data preparation phase. The output of this step 310 may be used to build two other language models, namely L_{D} and L_{H}, and evaluate their performances against L_{BASE} (cf., sections 3 and 4).

The URL Decompounding Transducer

The URL decompounding transducer (or decompounder) may be built from the annotated data table that is the result of the first step in the data preparation phase (cf. FIG. 3). Let Q be the set of queries in this table, and let U be the set of substrings of these queries that are labeled URLs. For a string s of length k let I(s) be the transducer that maps each character in s to itself; i.e., the i-th transition in I(s) has input and output label s(i). Further, let T(s) be the transducer that maps the sequence of characters in s to s; i.e., the first transition in T(s) has input s(1) and output s, and the i-th transition, where i≠1, has input s(i) and output epsilon. For a set of strings S, we define

I(S)=⊕_{sεS}I(s).

and similarly,

T(S)=⊕_{sεS}T(s)

where
⊕

is the union operation on transducers.

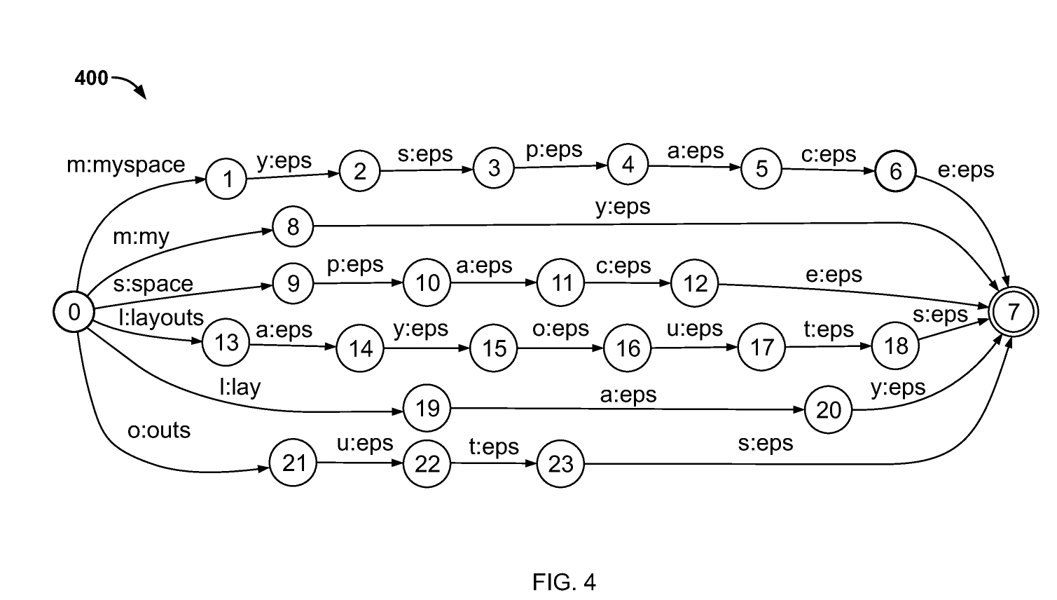

FIG. 4 illustrates the operation of T(•).

The decompounder may be built as follows in one implementation:
1. The queries in Q and their frequencies are used to train an LM L_{BASE}. Let V_{BASE} be its vocabulary.
2. For each u in the set of U, define N(u) as,

N(u)=bestpath(I(u)∘T*(V_{BASE})∘L_{BASE}) (1)

where ‘*’ is the Kleene Closure, and ‘∘’ is the composition operator.
3. is the

$$N ( U ) = {⊕}_{u ∈ U} N ( u )$$

URL decompounder.

The transducer I(u)∘T*(V_{BASE}) represents the lattice of all possible segmentations of u using the words in V_{BASE}, where each path from the start state to a final state in the transducer is a valid segmentation. The composition with the LM L_{BASE} scores every path. Finally, N(u) is the path with the highest probability; i.e. the most likely segmentation.

As mentioned above, a possible advantage of the described systems and methods is that they utilize a language model to determine the segmentation of highest probability, thus they can more accurately predict the correct sequence of decompounded words.

Note that the procedure N(•) defined in equation (1) can be used to segment any given string whose constituent words belong to the vocabulary, and below it is shown how it performs (in terms of word error rate) on a set of URLs. The decompounding transducer N(U), on the other hand, which is constructed in Step 3 above may only accept URLs on which it has been trained. In the next section, it is described how this transducer can be used for enhancing the performance of the base LM L_{BASE} within a speech recognition system. In some implementations, N(U) is representative of the trained automaton 110 in FIG. 1.

Experimental Setup

The performance of three language models all of which are trigram models will be compared. Table 2 shows the sizes of these models. There is no frequency cutoff on the n-grams; however, it is eliminated from the vocabulary terms appearing less than 2,000 times.

TABLE 2
Sizes of the three tested language models.

| | LBASE | LD | LH |
|---|---|---|---|
| Vocabulary size × 10³ | 996.07 | 915.52 | 917.63 |
| n-gram count × 10⁹ | 12.72 | 12.68 | 12.68 |

The first LM evaluated is L_{BASE}, which as discussed in Section 2 is trained using the annotated data generated by the first data preparation step depicted in FIG. 1. The set U used to generate the URL decompounder N(U) contains the most frequent 3 million queries (or substrings) annotated as URLs in this data. Note that since the vocabulary V_{BASE} is pruned, it includes only the 150,000 most frequent URLs as terms. In some implementations V_{BASE} is not trained on decompounded data.

The data for the second LM, L_{D}, is generated by executing a second distributed computation on the annotated data. As shown in FIG. 1 the second step in the data preparation phase performs context-aware normalization on the URLs in the data. Specifically, it decompounds every string marked a URL by composing it with the URL decompounder N(U). That is, if u is a URL, the single-path transducer I(u)∘N(U) is computed and the output symbols on its transitions are returned separated by spaces.

The data for the third LM, L_{H}, is also generated via a second computation on the annotated data. However, in this preparation step for L_{H}, normalization of the URLs is done slightly differently than the normalization used for L_{D}. Given a URL u, here u is only decompound if it does not belong to the set of 3,000 most frequent URLs U_{T}⊂U (these URLs appear more than 100,000 times in the training data). Otherwise, u is left intact. As mentioned in the introduction, N(U) can aid in automatically generating pronunciations for URLs by decompounding them into their constituent words.

This is simulated and it is assumed that using N(U) pronunciations for the URLs in U_{T} are obtained. Hence, when preparing the training data for L_{H} only the URLs in U\ U_{T} need to be decompounded.

Test data is extracted from a source that is different than that producing the input query data from which our LMs are built. Recall that we wish to test the performance of our language models on URLs in their spoken form. Let the set of URLs in our test set be Uₜ, and let the true segmentation of a URL u be O(u). We replace Uₜ in the test set with,

O(Uₜ)={O(u):uεUₜ}

when measuring the performance of L_{BASE} and L_{D}. On the other hand, we measure the performance of L_{H} using,

Õ(Uₜ)=(Uₜ∩U_{T})∪O(Uₜ\U_{T})

instead of Uₜ. That is, if a URL in the test set belongs to the top 3,000 URLs, then we assume we have a pronunciation for it and we recognize with it directly; otherwise, we use the URL's spoken form. In order to test the benefit of using the decompounder for generating pronunciations only, we also test the performance of L_{BASE} using Õ(Uₜ), and we refer to it (when reporting its results using this test setup) as L_{BASE-P}. Finally, note that the URLs in Uₜ are hand-segmented. In the next section, we present the results of our experiments.

Results

We evaluate the performance (in terms of perplexity) of the four language models L_{BASE}, L_{BASE}-P, L_{D}, and L_{H} on a test set Qₜ of 11.6K queries. The number of URLs in Qₜ is |Uₜ|=567, and almost half of these URLs are in U_{T}. The variants of the test set are prepared so that they contain no out-of vocabulary words. Recall that L_{BASE} and L_{D} (resp. L_{BASE-P} and L_{H}) are tested using O(Uₜ) (resp. Õ (Uₜ)) instead of Uₜ, and that L_{BASE-P}=L_{BASE} (cf. Section 3). Hence, there is a mismatch in the number of scored words between the two pairs of models. In order to allow for a fair comparison, we normalize the perplexity PP and present our results in terms of Adjusted Perplexity APP defined by,

$${ARP}_{i} = {2}^{\frac{{N}_{i}}{ma {x}_{j} {N}_{j} } lo {g}_{2} {PP}_{i}} = {PP}_{i}^{( {N}_{i} / ma {x}_{j} {N}_{j} )} \qquad ( 2 )$$

where i,jε{L_{BASE}, L_{D}, L_{BASE-P}, L_{H}}, and Nᵢ denotes the number of n-grams used to evaluate LMᵢ.

The results are presented in Table 3.

TABLE 3
Perplexity results for the tested language models.

| | Test-set # n-grams | PP | APP |
|---|---|---|---|
| L_{BASE} | 43572 | 151.71 | 151.71 |
| L_{D} | 43572 | 130.96 | 130.96 |
| L_{BASE-P} | 42792 | 151.97 | 138.90 |
| L_{H} | 42792 | 142.15 | 130.08 |

The LM L_{D} trained on decompounded URLs achieves a 13.7% relative reduction in perplexity over the baseline LBASE. Note that its vocabulary is also 8% smaller (cf. Table 2). On the other hand, LBASE-P, which assumes pronunciations for the top 3,000 URLs achieves a 8.4% reduction with respect to LBASE. The LM LH, which combines the two approaches, achieves the largest relative adjusted perplexity reduction of 14.3% with respect to LBASE (and 0.7% with respect to LD). The main reduction in the perplexity of LH comes from training on segmented URLs. These results show that although overlapping, the two approaches to utilizing the decompounder complement each other improving performance and resulting in a smaller vocabulary.

In order to test the quality of our decompounding technique, we evaluate the WER on a set of 648 URLs that were hand-segmented, resulting in 1,404 words. Since we wish to measure how well our decompounder performs for preparing URLs for training, this test set is extracted at random from our training data. For each URL u in this set, we generate its segmented version N(u) per Equation (1) using LBASE and VBASE, and we compare it to its true segmentation. Our decompounding procedure achieves a word error rate (WER) of 10%. Note that evaluation is based solely on the segmentation of compounded words and does not consider segmentation around punctuation; e.g., in www.walkforthehomeless.net we only concern ourselves with correctly segmenting walkforthehomeless. Table 4 depicts example outputs of our procedure.

TABLE 4
Segmentations using Eq. 1 vs. true segmentation.

| N(u) | True |
|---|---|
| louisiana • wildlife • and • fisheries | ″ |
| cancer • treatement • centers • of • america | ″ |
| hymns • and • carols • of • Christmas | ″ |
| total • printing • solutions | ″ |
| the • movie • store | ″ |
| myspace • layouts | my • space • |
| utexas | u • texas |

We find that most errors are related to having the compounded form as a word whose probability is high in the LM that is utilized by the decompounding procedure. The last two examples in Table 4 are instances of this phenomena. The myspace example shows how current trends, as inferred from the query language model LBASE, influence the decompounding process.

In some implementations, the LBASE is used to construct the decompounder. In some implementations, the size of the LM used for constructing the decompounder is varied. In some implementations, the performance (in terms of a word error rate) of LBASE versus LH in a speech recognition system is compared.

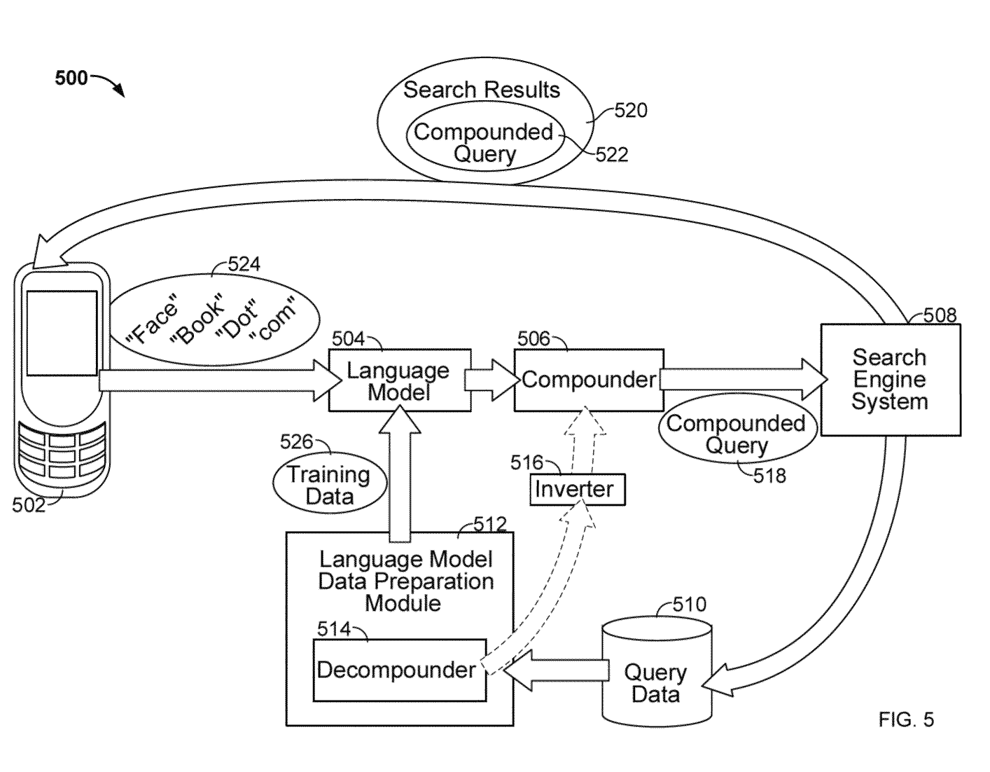

FIG. 5 is an example system for compounding spoken words. As an illustration, a user of telephone speaks the query “Face Book Dot Com” into the telephone 502. The recorded audio stream is transmitted through a network to a language model 504. In some implementations, the language model 504 has been trained by a language model data preparation module 512 using query data 510, for example, using the processes described previously.

The language model identifies the received audio stream query as including the separate words “Face” “Book” “Dot” and “Com.” The system 500 determines if the received sequence of words is associated with a URL by passing the sequence through a compounder 506. If a received sequence of words corresponds to URL known to the system 500, the compounder outputs the URL. If the sequence of words is not associated with a URL known to the system 500, then the compounder outputs an appropriate identifier (e.g., “0” or an error token).

In some implementations, the compounder generated by inverting 516 the decompounder 514. For example, the trained automaton 110 (in FIG. 1) is inverted. As described previously, the trained automaton 110 receives as input a URL string and outputs the constituent words (if the URL is recognized). Inverting this transducer provides a system that receives the constituent words for a recognized URL and outputs the concatenated URL. Therefore, the compounder 506 compounds those sequences of words previously used to generate a finite state transducer (e.g., the finite state transducer used to train the language model 504).

The compounder 506 outputs a compounded query 518 that is transmitted to a search engine system 508 for generating search results that are probabilistically associated with the spoken audio stream 524. For example, a user of the telephone may have spoken “How Many People Use Face Book Dot Com.” If the user had typed the query into a web page provided by the search engine system 508, the user may have typed “How many people use Facebook.com.” The search engine may include an interface that receives either the spoken query or the text query from the remote device. The search engine may be optimized to provide most relevant results where the received queries include a URL (as opposed to its spoken constituent words). Thus, system 500 uses a compounder 506 to concatenate the user's spoken words 524 into the compounded query “How many people use Facebook.com” 518.

The search engine system 508 identifies search results 520 that are responsive to the compounded query 518 and provides the search results to the mobile device 502. In some implementations, the search engine system also provides the compounded query 522 to the mobile device 502. The compounded query 522 can be visually displayed on the mobile device 502. The display of the query 522 allows a user of the mobile device 502 to verify that the compounded query 522 is the query that the user spoke into the mobile device 502. In some implementations, the compounder 506 provides the compounded query 518 to the mobile device 502 instead of the search engine system.

In some implementations, queries received by the search engine system 508 are stored as query data 510 and used by a language model data preparation model 512 to train the language model 504. For example, the language model 504 may have initially been trained using query data 510 that did not include navigational queries. Along with the training, a decompounder 514 can be generated, as described above. The decompounder can be used to generate the compounder (e.g., by applying an inverse function to the decompounder). Aside from training the language model 504, this training generates a decompounder 514 (which can be necessary to create the compounder). After this training, however, a new language model 504 can be generated with a new set of training data 526. The new training data 526 can include decompounded words and frequency data from voice queries (e.g., query 524).

In some implementations, the compounder 506 receives an sequence of words, of which only a subset is a navigational query. The compounder 506 may be able to identify the subset that is a navigational query, transform the subset into the navigational query, and otherwise output the words that are not identified as constituent words of a URL. For example, if the query “Is Face Book Dot Com Or My Space Dot Com More Awesome” input into the compounder 506, the output 518 can be “Is Facebook.com or Myspace.com more awesome.”

In some implementations, the lattice automaton 108 is the automaton that is inverted to generate the compounder 506. In this implementation, the edges in the lattice automaton 108 may include or be associated with probabilities. Because each URL can be associated with several outputs of constituent words (e.g., “go this land” or “goth island,” inputting either set of constituent words into the compounder 506 can result in the compounder 506 outputting the compounded query 518 “gothisland.com.” In some implementations, the compounder 506 is the dame structure as the decompounder, but with an inverter applied

In various implementations, the compounder 506 can output a compounded string 518 to a component other than a search engine system 508. For example, the output string 518 can be input into a word processing document being created by a user with a voice recognition system. For example, the user may open a word processing document and speak into a microphone “My diary entry for November Twelfth, Two-Thousand and Twenty Four. Today I deleted my Face Book Dot Com Account. Freedom at last.”

In various implementations, the systems described above can work with concatenated strings that are not URLs. In some implementations, the strings compounded or decompounded by the systems described herein include “www,” “.com,” “.org” or other non-content URL information (e.g., internet domain names or domain name suffix information). In these implementations, the content URL information (e.g., “facebook” or “face book”) can be identified in a database as a URL or a portion of a URL.

In various implementations, a URL is not received as part of a search query but as a direct navigational query. For example, instead of touching a search engine query box on a display of the mobile telephone 502 and saying the query “Face Book Dot Com,” a user of the telephone 502 may touch on the display an address bar of an Internet browser and say the URL “Face Book Dot Com.”

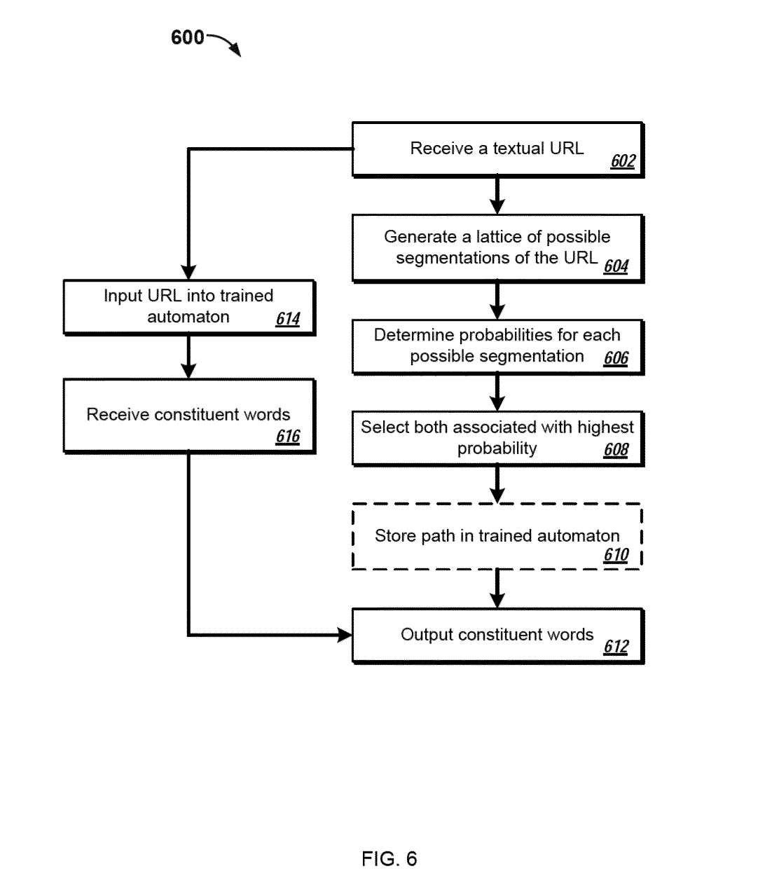

FIG. 6 is a flow chart of an example process for identifying constituent words in a URL. In box 602, a textual URL is received. For example, a server system may receive a set of queries, with some of the queries including navigational queries (e.g., URLs). The set of queries may be received as training data for a language model. In another example, a single URL is received. The single URL may have been typed into a computer by a user of the computer.

In box 614, the received URL is input into a trained automaton. The trained automaton identifies, for a number of URLs, the determined set of most probable constituent words for each URL. As an illustration, the query “www.cancercentersofamerica.com” can be received and input into the trained automaton. In some implementations, the content of the URL is extracted from the URL and only the content is input into the automaton. For example, the “www” and “com” may be stripped from the URL string and “cancercentersofamerica” may be input into the automaton.

In box 616, the constituent words of the URL are received from the trained automaton. Continuing with the previous illustration, the constituent words “cancer” “centers” “of” “america” are received.

In step 612, the constituent words are output. In some implementations, the constituent words for several URLs are collected along with the frequency of the constituent words. The collection of constituent words and frequency information is output as training information for training a language model. In other implementations, the constituent words are supplied to a speech recognition system. For example, an application program may use the process 600 to read text from a web page and generate a spoken version of the text (e.g., for the visually impaired).

In box 604, a lattice of possible segmentations for the received URL is generated. For example, a dictionary of terms can be used in an identification of all the constituent words in a URL. The generated lattice can represent all potential segmentations of the URL into the constituent words. The lattice can be a finite state transducer or a finite state table, in some examples.

In box 606, probabilities for each of the possible segmentations of the URL are determined. For example, a language model can assign probabilities to each path through the lattice.

In box 608, the path associated with the highest probability is selected. This path represents the most probable segmentation of a URL based on the training of a language model.

In optional box 610, the selected path is stored in a trained automaton. Storing the path in a trained automaton enables the process 600 to identify the constituent words of subsequently received same URL without generating a lattice and determining the probabilities for each segmentation.

In box 612, the constituent words of the selected path are output, as described above.

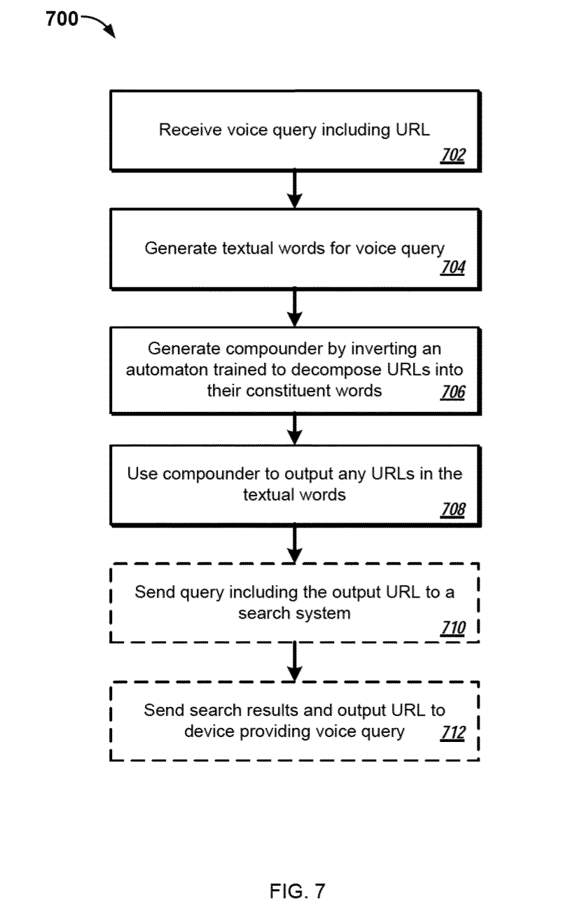

FIG. 7 is a flow chart of an example process for generating a URL from a spoken representation of the URL. In box 702 a voice query that includes a URL is received. For example, a search engine server system may receive a voice query from a mobile telephone. A user of the mobile telephone may have opened a search engine application, pressed a button to initiate a voice query, and spoken the words “Is cnn.com the most popular website?” into a microphone of the telephone. This voice query includes the URL cnn.com, although the URL sounds like “see en en dot com.”

In box 704, textual words for the voice query are generated. The words are generated using a language model. The textual representation of the words, after processing using the language model, may be “Is c n n dot com the most popular website.”

In box 706, a compounder is generated. The generation of the compounder can include applying an inversion transformation to an automaton trained to decompound URLs into their constituent words. The compounder can accept a sequence of text words and output a textual URL if identified by the compounder.

In some implementations, the trained decompounding automaton may be generated during a training of the language model. The training can include providing a set of URLs to the decompounder, and then providing the constituent words and frequency data as language model training data. The decompounder can identify, for all URLs that can are input into the decompounder and can be segmented, the constituent words of the most probable segmentation of each URL.

In box 708, the compounder is used to output any URLs in the textual words. For example, “c n n dot com” may be transformed into “cnn.com.” If text words are input that are not associated with a URL, they may remain un-concatenated For example, if “is c n n dot com the most popular website” is input into the compounder, the output can include “is cnn.com the most popular website.”

In optional box 710, the query including the output URL is sent to a search system. For example, “is cnn.com the most popular website” can be provided to a search engine system as a query. The search engine system can generate search results that are responsive to the query.

In optional box 712, the search results and the query are provided to the device that supplied the voice query. For example, the search engine system may transmit the text “is cnn.com the most popular website” along with corresponding search results to a mobile telephone that sent the voice query to the search engine system.

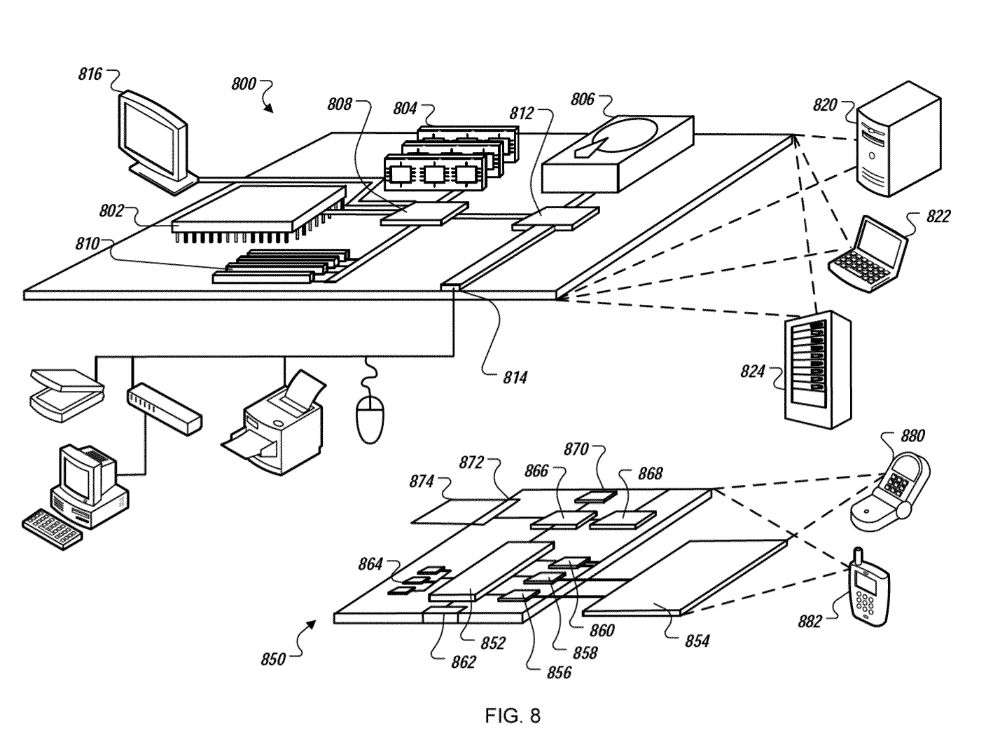

FIG. 8 is a block diagram of computing devices 800, 850 that may be used to implement the systems and methods described in this document, as either a client or as a server or plurality of servers. Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smartphones, and other similar computing devices. Additionally computing device 800 or 850 can include Universal Serial Bus (USB) flash drives. The USB flash drives may store operating systems and other applications. The USB flash drives can include input/output components, such as a wireless transmitter or USB connector that may be inserted into a USB port of another computing device. The components shown here, their connections and relationships, and their functions, are meant to be exemplary only, and are not meant to limit implementations of the inventions described and/or claimed in this document.

Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. Additionally, the processor may be implemented using any of a number of architectures. For example, the processor 410 may be a CISC (Complex Instruction Set Computers) processor, a RISC (Reduced Instruction Set Computer) processor, or a MISC (Minimal Instruction Set Computer) processor. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT (Thin-Film-Transistor Liquid Crystal Display) display or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provide in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 874 may also be provided and connected to device 850 through expansion interface 872, which may include, for example, a SIMM (Single In Line Memory Module) card interface. Such expansion memory 874 may provide extra storage space for device 850, or may also store applications or other information for device 850. Specifically, expansion memory 874 may include instructions to carry out or supplement the processes described above, and may include secure information also. Thus, for example, expansion memory 874 may be provide as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 874, or memory on processor 852 that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, WiFi, or other such transceiver (not shown). In addition, GPS (Global Positioning System) receiver module 870 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smartphone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), peer-to-peer networks (having ad-hoc or static members), grid computing infrastructures, and the Internet.

The computing system can include clients and servers. A client and server are generally remote from each other and typically interact through a communication network. The relationship of client and server arises by virtue of computer programs running on the respective computers and having a client-server relationship to each other.

Although a few implementations have been described in detail above, other modifications are possible. For example, compounded text is not limited to URLs. In some implementations compounded text may include written languages that do not necessarily segment words with spaces even though the spoken words included pauses between the words (e.g., some forms of Arabic or Asian languages).

Additionally, the ‘n’ of the n-gram can be any integer (e.g., 2, 3, or 4). The n-gram may be selected base on a performance/memory cost analysis, where a greater integer may produce more accurate results for a greater memory cost.

Also, in some implementations, spoken queries that include a spoken form of the URL are entered using computing devices that are not mobile, such as desktop computers equipped with a microphone or other speech input device.

In some implementations, the use of FSTs can be circumvented by considering all the possible 2̂(n−1) combinations of spaces and no-spaces that can be inserted between the characters of the string. Given a LM, the system can then find each segmentation's probability and output the segmentation with highest probability.

In some implementations, a language model trained on search queries per se need not be used. It may suffice that the LM is trained on data from a domain that is compatible with the domain of the text that is to be segmented.

In other implementations, a language model can be considered an encoding of the statistics of the text on which it is trained. Any other appropriate probability distribution over words may suffice. That is, any appropriate method can be used that given a sequence of words returns their probability of occurrence to score the different segmentations of the compounded text.

In addition, logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1-9. (canceled)

10. A computer-implemented method comprising:
receiving, by a computing system, a textual uniform resource locator (URL) that was extracted from one or more text search queries that were submitted to a search engine, wherein the textual URL comprises a plurality of individual words that are joined together without intervening spaces;
accessing, by the computing system, an electronic dictionary that includes a plurality of words;
generating, by the computing system, a data structure that represents possible segmentations of the textual URL based on whether words in the possible segmentations occur in the electronic dictionary;
determining, by the computing system, a segmentation of the textual URL that is a most probable segmentation of the textual URL based on a frequency of occurrence of each of the possible segmentations of the textual URL;
receiving, by the computing system, audio data that includes a human spoken query and that was recorded by a microphone of a computing device;
identifying, by the computing system and through use of a language model, a textual form of words in the spoken query;
determining, by the computing system and in response to receiving the audio data, that the textual form of at least some of the words in the spoken query matches the determined segmentation of the textual URL; and
transmitting, by the computing system and to a search engine system in response to determining that the textual form of at least some of the words in the spoken query matches the determined segmentation of the textual URL, a textual query that includes the textual URL.

11-25. (canceled)

26. The computer-implemented method of claim 10, comprising:
sending, by the computing system and for receipt by the computing device, multiple search results that the search engine system determined were responsive to the textual query.

27-28. (canceled)

29. The computer-implemented method of claim 10, wherein:
the textual form of the words in the spoken query includes a textual representation of a spoken word (dot), and
the textual URL that is included in the textual query includes a character (.) and does not include the textual representation of the spoken word (dot).

30. The computer-implemented method of claim 10, wherein:
the textual form of the words in the spoken query includes one or more words in addition to the at least some of the words in the spoken query that match the determined segmentation of the textual URL; and
the textual query, that the computing system transmits to the search engine system, includes the one or more words in addition to the textual URL.

31. The computer-implemented method of claim 10, further comprising:
identifying that substrings of the one or more text search queries are URLs, wherein the textual URL is one of the substrings that has been identified as a URL.

32. The computer-implemented method of claim 10, further comprising:
determining whether the textual form of the at least some of the words in the spoken query is associated with any URLs by comparing the textual form of the at least some of the words in the spoken query with determined segmentations of multiple different URLs.

33. The computer-implemented method of claim 10, wherein:
the language model has been trained using (i) the segmentation of the textual URL that has been determined to be the most probable segmentation of the textual URL, and (ii) segmentations of other URLs that have been determined to be the most probable segmentations of the other URLs.

34. The computer-implemented method of claim 10, wherein users typed the one or more text search queries.

35. The computer-implemented method of claim 10, further comprising:
identifying constituent words in the textual URL, comprising:
(a) the receiving the textual URL,
(b) the accessing the electronic dictionary,
(c) the generating the data structure, and
(d) the determining the segmentation of the textual URL; and
generating the textual URL from the human spoken query, comprising:
(e) the receiving the audio data,
(f) the identifying the textual form of the words in the spoken query,
(g) the determining that the textual form of the at least some of the words in the spoken query matches the determined segmentation of the textual URL, and
(h) the transmitting the textual query.

36. One or more computer-readable media including instructions that, when executed by one or more programmable processors, perform operations that comprise:
receiving, by a computing system, a textual uniform resource locator (URL) that was extracted from one or more text search queries that were submitted to a search engine, wherein the textual URL comprises a plurality of individual words that are joined together without intervening spaces;
accessing, by the computing system, an electronic dictionary that includes a plurality of words;
generating, by the computing system, a data structure that represents possible segmentations of the textual URL based on whether words in the possible segmentations occur in the electronic dictionary;
determining, by the computing system, a segmentation of the textual URL that is a most probable segmentation of the textual URL based on a frequency of occurrence of each of the possible segmentations of the textual URL;
receiving, by the computing system, audio data that includes a human spoken query and that was recorded by a microphone of a computing device;
identifying, by the computing system and through use of a language model, a textual form of words in the spoken query;
determining, by the computing system and in response to receiving the audio data, that the textual form of at least some of the words in the spoken query matches the determined segmentation of the textual URL; and
transmitting, by the computing system and to a search engine system in response to determining that the textual form of at least some of the words in the spoken query matches the determined segmentation of the textual URL, a textual query that includes the textual URL that includes the plurality of individual words that are joined together without intervening spaces.

37. The one or more computer-readable media of claim 36, wherein the operations further comprise:
sending, by the computing system and for receipt by the computing device, multiple search results that the search engine system determined were responsive to the textual query.

38. The one or more computer-readable media of claim 36, wherein:
the textual form of the words in the spoken query includes a textual representation of a spoken word (dot), and
the textual URL that is included in the textual query includes a character (.) and does not include the textual representation of the spoken word (dot).

39. The one or more computer-readable media of claim 36, wherein:
the textual form of the words in the spoken query includes one or more words in addition to the at least some of the words in the spoken query that match the determined segmentation of the textual URL; and
the textual query, that the computing system transmits to the search engine system, includes the one or more words in addition to the textual URL

40. The one or more computer-readable media of claim 36, wherein the operations further comprise:
identifying that substrings of the one or more text search queries are URLs, wherein the textual URL is one of the substrings that has been identified as a URL.

41. The one or more computer-readable media of claim 36, wherein the operations further comprise:
determining whether the textual form of the at least some of the words in the spoken query is associated with any URLs by comparing the textual form of the at least some of the words in the spoken query with determined segmentations of multiple different URLs.

42. The one or more computer-readable media of claim 36, wherein:
the language model has been trained using (i) the segmentation of the textual URL that has been determined to be the most probable segmentation of the textual URL, and (ii) segmentations of other URLs that have been determined to be the most probable segmentations of the other URLs.

43. The one or more computer-readable media of claim 36, wherein users typed the one or more text search queries.

44. The computer-implemented method of claim 36, wherein the operations further comprise:
identifying constituent words in the textual URL, comprising:
(a) the receiving the textual URL,
(b) the accessing the electronic dictionary,
(c) the generating the data structure representing, and
(d) the determining the segmentation of the textual URL; and
generating the textual URL from the human spoken query, comprising:
(e) the receiving the audio data,
(f) the identifying the textual form of the words in the spoken query,
(g) the determining that the textual form of the at least some of the words in the spoken query matches the determined segmentation of the textual URL, and
(h) the transmitting the textual query.
